(19) United States
(12) Patent Application Publication
(10) Pub. No.: US 2026/0037870 A1
(43) Pub. Date: Feb. 5, 2026

(54) System and Method for Training a Machine Learning Model

(71) Applicant: Sony Interactive Entertainment Inc., Tokyo (JP)

(72) Inventors: Ryan John Spick, London (GB); Pierluigi Vito Amadori, London (GB)

(21) Appl. No.: 19/285,706

(22) Filed: Jul. 30, 2025

(30) Foreign Application Priority Data
Jul. 30, 2024 (GB) 2411136.1

(51) Int. Cl. G06N 20/00; G06V 10/70

(52) U.S. Cl. CPC G06N 20/00; G06V 10/768

(57) ABSTRACT

A system for training a machine learning model comprises a receiving unit configured to receive first data comprising an attribute sequence providing a sequence of values each indicating whether a particular attribute is associated with a respective one of a sequence of training frames, training frames so associated being referred to as key frames, a training unit configured to train the machine learning model, using a training dataset, to generate behaviour for an agent to predict occurrence of the particular attribute within a sequence of action frames, and a filtering unit configured to apply a filter to the attribute sequence to generate the training dataset, wherein the filter modifies values of the attribute sequence for at least some training frames proximate to a given key frame, to provide context information in the training dataset indicating proximity to a key frame for frames within the sequence of training frames.

### CROSS-REFERENCE TO RELATED APPLICATIONS

This application claims the benefit of priority to U.K. Application No. 2411136.1, filed on Jul. 30, 2024, the contents of which are hereby incorporated by reference.

### TECHNICAL FIELD

The present disclosure relates a system and method for training a machine learning model.

### BACKGROUND

Interest in machine learning and artificial intelligence techniques has increased significantly in recent years, with such techniques finding applications in a wide range of subject areas. Such techniques may be considered advantageous in that they can lead to improved results versus a more rules-based program directed towards solving a particular program—for instance, through finding improved solutions to a particular problem and/or through being more adaptable to the specific parameters of new problems.

There are a number of different ways of training models in accordance with these techniques, each having their own advantages and disadvantages. For example, reinforcement learning is a generally successful training approach that is considered to be particularly suitable for applications in which rewards (such as the completion of a goal) are able to be well-defined and provided at regular intervals. Imitation learning is another training approach, and may be considered particularly suitable for the training of particular behaviours. Typically in imitation learning an expert will be used to generate training data (such as a video of them completing a particular activity) and a set of such data will be provided as a training dataset.

Whilst machine learning models have achieved successes, data imbalance is an issue in training machine learning models, where one or more classes in a training dataset are underrepresented. This can have a negative impact on training, as the model may learn to be biased towards more frequently occurring classes, compared to less frequently occurring ones.

It is in the context of the above discussion that the present disclosure arises.

### SUMMARY

At least some examples provide a system for training a machine learning model, the system comprising:
a receiving unit configured to receive first data comprising an attribute sequence providing a sequence of values indicating whether a particular attribute is associated with each of a sequence of training frames, training frames so associated being referred to as key frames;
a training unit configured to train the machine learning model, using a training dataset, to generate behaviour for an agent to predict occurrence of the particular attribute within a sequence of action frames; and
a filtering unit configured to apply a filter to the attribute sequence to generate the training dataset, wherein the filter modifies values of the attribute sequence for at least some training frames proximate to a given key frame, to provide context information in the training dataset indicating proximity to a key frame for frames within the sequence of training frames.

At least some examples provide a system for using a machine learning model to provide game inputs, the system comprising:
a game state capturing unit configured to capture game state information representing a sequence of action frames of a game;
prediction circuitry configured to provide the game state information to a machine learning model trained using the system described above to predict occurrence of a particular attribute within the sequence of action frames; and
game input providing circuitry configured to provide a game input determined based on which, if any, of the action frames are predicted to be associated with the particular attribute

At least some examples provide a method of training a machine learning model, the method comprising:
receiving training data comprising an attribute sequence providing a sequence of values indicating whether a particular attribute is associated with each of a sequence of training frames;
applying a filter to the attribute sequence to generate a training dataset, wherein the filter is arranged to modify values of the attribute sequence for non-attribute training frames not associated with the particular attribute to provide context information indicating that a training frame nearby in the sequence of training frames is an attribute training frame associated with the particular attribute; and
training the machine learning model, using the training dataset, to generate behaviour for an agent to predict occurrence of the particular attribute within a sequence of action frames.

Further respective aspects and features of the disclosure are defined in the appended claims.

It is to be understood that both the foregoing general description of the present disclosure and the following detailed description are exemplary, but are not restrictive.

### BRIEF DESCRIPTION OF THE DRAWINGS

FIG. 1 illustrates an example of an entertainment system;

FIG. 2 schematically illustrates an apparatus for training and using a machine learning model according to examples of the present technique;

FIGS. 3 to 6 graphically illustrate examples of applying a filter to an attribute sequence;

FIG. 7 schematically illustrates an example arrangement for training a machine learning model and optimising filter parameters;

FIG. 8 is a flow diagram illustrating a method of training a machine learning model;

FIG. 9 is a flow diagram illustrating a method of using a machine learning model to control a video game; and

FIG. 10 is a flow diagram illustrating a method of training a machine learning model and filter parameters in a combined approach.

### DETAILED DESCRIPTION

As introduced above, data imbalance is an issue in training machine learning models where one or more classes in a dataset are underrepresented. In examples discussed below, a dataset may comprise a sequence of training frames, each training frame representing a particular sample of input data. For instance, a sequence of training frames may represent a temporal series of snapshots of an activity used for training, such as a series of frames of a video game. An attribute sequence may be provided indicating whether a particular attribute (also described as a label) is associated with each of the sequence of training frames, where training frames associated with the particular attribute may be referred to as key frames.

The particular attribute may vary based on the machine learning model being trained, as discussed below. For example, the attribute may represent an expected user input for the key frames, or may represent a classification of image data associated with a key frame, for example. In general the attribute may be an infrequent attribute which is underrepresented within the overall set of training data, meaning that key frames represent a small fraction of overall training frames. This can lead to a poor performance from a model that is trained using this dataset.

Machine learning techniques in which this situation arises include imitation learning (IL) seeking to train a machine learning model to select the most appropriate actions and/or policies in response to a current state of an environment (which may be real or virtual). Hence typically the snapshots are used in sequence as an input, and the attributes are provided as target outputs, as and when they occur in their corresponding sequence. Hence imitation learning provides the model with a training dataset which comprises both environment states and the most appropriate action/policy to take in response to such environment states (e.g., the actions which may be taken by an expert), which may be provided as an attribute sequence where the attribute represents whether a particular action should be taken for each of a series of training frames representing environment states. When this training dataset is provided to an IL agent, the IL agent learns to ‘predict’ (i.e. imitate) the actions/policies carried out by the expert and also learns the context (environment states) in which the actions/policies were carried out so that when a similar context arises in the subsequent utilisation of the trained IL agent, the agent may carry out the actions/policies that it has learnt to imitate, and thus respond to the context in the most appropriate/desired manner.

However, if the most appropriate action only arises rarely in the training data, then the imitation learner may be biased towards not taking the most appropriate action in the subsequent utilisation of the trained IL model.

It will however be appreciated that the techniques discussed herein may be applicable to other types of machine learning. For instance, when training a model to classify image data it may be the case that whether a particular training frame comprises a particular attribute (e.g., whether an image contains a person's face) can be represented by an attribute sequence provided in the training dataset alongside a sequence of training frames representing images of a video. If the attribute is infrequent in the training dataset, then an image classification model trained according to the training dataset may be biased towards not identifying the attribute within an image (and hence incorrectly classifying the image) when the trained model is subsequently utilised.

The techniques discussed herein may be considered to be particularly suitable for applications in which an agent is to learn behaviour; this can find applications in a number of areas, such as self-driving cars, navigation of an environment (real or virtual) by an agent, and playing video games. It is on the latter of these that the present disclosure focuses, to aid the clarity and conciseness of the disclosure, but the techniques described should not be considered to be limited to such an application. Instead, it is considered that the techniques may be applied to machine learning for a wide range of applications.

To provide a particular example of the problem of underrepresented attributes in a training dataset, consider a video game dataset for training a model to play video games. The training data may comprise video recordings or the like which represent the gameplay of a real player, and one or more attribute sequences may be provided to indicate whether a user should take a particular action for each training frame within the gameplay. A training frame may for example comprise image data representing a particular frame of the video game, pre-processed image data reduced to a set of parameters, and/or raw game data classifying a current state of the game at a particular point, and so on. Once trained, the model may be used for a variety of applications, including non-player character control (such as opponents for a multiplayer game, and optionally opponents who could or might otherwise have been controlled by other players) and quality control testing for an in-game environment, thereby automating test play. In use the model may be provided with a sequence of action frames representing the state of a game (in a similar format to the training frames used to train the machine learning model), and be used to predict whether each action frames should be associated with the particular attribute to determine whether the corresponding action should be taken in that frame or not. Training the machine learning model to respond correctly to infrequent attributes may be important for the training process, because while certain actions may be infrequent in a video game, they may nevertheless be important in the context of the game.

For example, a jumping command (which may be represented by a particular button press) may occur during a very small percentage of training frames in a training dataset. If jumping commands are underrepresented in the dataset, the trained agent might be biased towards “not-jumping”, as it is the most common action, and predict an incorrect action where jumping is required, e.g., to jump over an obstacle.

The inventors have realised that an issue with infrequently occurring binary attributes, such as jumping (1) and not jumping (0), is that the training frame in which the attributes occur may appear very abruptly in a sequence of training frames. Even if an obstacle is in front of an avatar in a particular training frame, the “jump” action may still not be pressed until the avatar is close enough to the obstacle. Finally, when the distance for the “jump” is considered optimal by the player, the button is only pressed for a short period of time. Hence, a series of similar training frames may only comprise a small number of key frames. A machine learning model is therefore confronted with the problem that similar training frames should have very different predicted outputs, with the machine learning model provided with little information regarding how to predict key frames within the sequence of training frames.

In examples of the present technique, a filter is applied to the attribute sequence to generate the training dataset. The filter modifies values of the attribute sequence for at least some training frames proximate to a given key frame (a key frame being associated with the particular attribute), to provide context information in the training dataset indicating proximity to a key frame for frames within the sequence of training frames. A proximate frame may directly precede or follow a key frame in a sequence of training frames, or may be separated from a key frame by one or more other proximate frames. The number of frames affected by the filter can be controlled by filter parameters and may vary from 1 to N, where N may correspond to several seconds of frames. Typically the effects of a filter on a point discontinuity such as a binary attribute are symmetrical and so propagate both forward and backward in the sequence. However, optionally one of these propagations may not be copied into the attribute sequence, or re-set to zero. Hence for example the result may be values ramping up to the original existing value over N frames before similarly ramping back down, or alternatively dropping immediately to zero after the original existing value (or vice versa).

Hence, the present technique adds some trailing and/or leading knowledge around binary positive actions (key frames) by changing the neighbouring binary negative values (negative in this context referring to absence of the attribute, which may be represented by an attribute value of 0). This shifts the problem faced by a machine learning model from a binary classification problem to a likelihood estimation problem. In other words, providing context information in the training dataset for frames surrounding a key frame enables the machine learning model to learn whether a particular frame is near to a key frame in the sequence of training frames, and can therefore allow the machine learning model to learn to expect a nearby key frame in a series of frames, and to potentially learn to discriminate any changes in features of the training frames that distinguish the proximal/contextual frames from the actual key frame.

In the jumping example given above, a series of training frames may represent an avatar approaching an obstacle. Without the present disclosure, the machine learning model is presented with a number of frames having an avatar next to an obstacle without the jump button pressed, and a small number of frames having the avatar next to the obstacle with the jump button pressed. Due to the similarity of frames with and without the jump button pressed, it is difficult for the machine learning model to assess when the jump command should occur. However, when the filter is applied to the attribute sequence, then the machine learning model is presented with a number of frames associated with an attribute sequence indicating an increasing likelihood of jumping as the avatar gets closer to the obstacle. This can allow the machine learning model to identify features of the training frames which are associated with an increased likelihood of jumping (e.g., reducing distance to the obstacle), which can enable the machine learning model to more accurately predict when to jump based on a series of frames. This can enable the machine learning model to display behaviour more representative of a player when presented with a new scenario.

It will be appreciated that the context information is not limited to training frames preceding a key frame. In some examples discussed below, providing context information in training frames following a key frame may also enable improved prediction of the attribute in a series of action frames.

A system for training a machine learning model is discussed in the following description. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

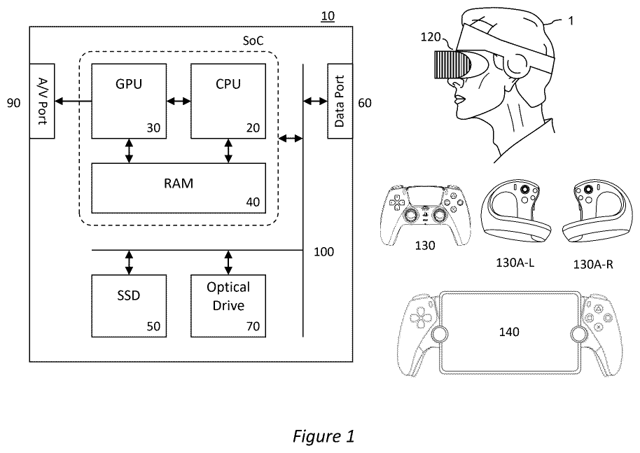

In an example embodiment of the present disclosure, the system may be provided by an entertainment system. As illustrated in FIG. 1, an example of an entertainment system 10 is a computer or console.

The entertainment system 10 comprises a central processing unit (CPU) 20. This may be a single or multi core processor. The entertainment system also comprises a graphical processing unit (GPU) 30. The GPU 30 can be physically separate to the CPU 20, with communication to the CPU 20 via a bus, or integrated with the CPU 20 as a system on a chip (SoC).

The entertainment device also comprises memory (e.g., random access memory (RAM)) 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, WiFi® port, Bluetooth® port or similar, as appropriate. It may also optionally receive data via an optical drive 70. Audio/visual outputs from the entertainment device are typically provided through one or more A/V ports 90, or through one or more of the wired or wireless data ports 60. Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, 140, and/or one or more VR controllers (130A-L,R) in the case of the HMD 120.

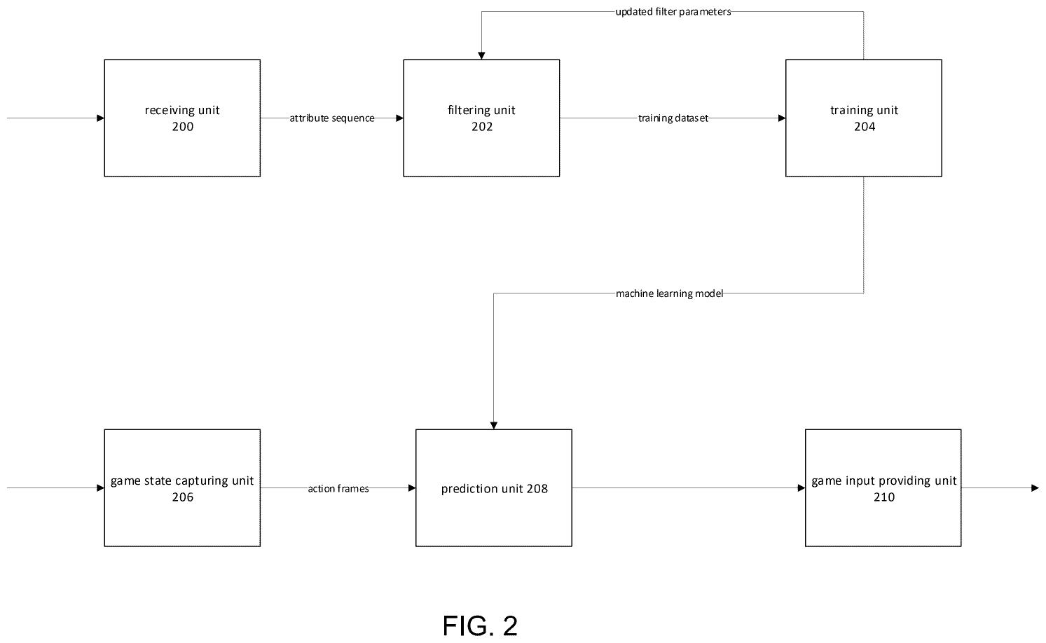

FIG. 2 schematically illustrates an apparatus for training a machine learning model according to examples of the present technique. The apparatus comprises at least a receiving unit 200, a filtering unit 202, and a training unit 204. The features of the apparatus shown in FIG. 2 may be provided within the system shown in FIG. 1, for example, within the CPU 20 and/or within dedicated circuitry configured to support training of a machine learning model, such as a neural processing unit (NPU).

The receiving unit 200 is configured to receive first data comprising an attribute sequence providing a sequence of values indicating whether a particular attribute is associated with each of a sequence of training frames, training frames so associated being referred to as key frames. The attribute sequence may for example be a binary sequence, each element of the binary sequence corresponding to a training frame in the sequence of training frames, and indicating whether that frame is a key frame.

The training frames may generally represent sampling points of training data. For example, if the training data comprises video data then training frames may correspond to regular snapshots of the video data. If the training data comprises footage of a video game, then training frames may correspond to snapshots of the game. The frequency at which training frames are defined within the training data may vary according to a sampling rate. A higher sampling rate may generate a larger volume of training data which may improve training quality but may also have a higher processor resource, such as power and storage, to handle.

The first data may also comprise input data representing the sequence of training frames. The input data (representing training frames during training and representing action frames during later inference) may comprise various types of data, such as numerical values, images, video, text, and/or audio. Raw input data may be pre-processed to obtain an appropriate feature vector used as an input to the model—for example, features of an image or audio input may be extracted to obtain a corresponding feature vector. It will be appreciated that the type of input data and techniques for pre-processing of the data may be selected based on the specific task the supervised learning model is used for. For example, where the training frames correspond to snapshots of a video game, the input data may comprise image and audio data representing the data presented to a player at each training frame. In some examples, the data representing the training frames may be pre-processed, and hence rather than comprising raw image data may comprise a filtered image or a parametric representation of an image (e.g., a set of parameters representing different aspects of the image).

By providing input data representing a sequence of training frames and an attribute sequence to a machine learning model, the machine learning model can learn to associate presence of an attribute (e.g., whether a particular action should be taken) with properties of the training frames. During training the model adjusts its internal parameters (e.g. weights) so as to optimize (e.g. minimize) an error function, aiming to minimize the discrepancy between the model's predicted outputs and the attribute sequence provided as part of the training data. One or more attribute sequences may be provided. For example, an attribute sequence may be provided for each action which could be taken by a user, to enable the machine learning model to predict behaviour of a player for each of the sequence of training frames.

Optionally, where the training frames are sampled at a period of less than every actual frame, it is possible that an input (e.g. corresponding to an attribute of 1) occurs in a frame that is not normally sampled. In this case, the attribute can be assigned to the previous or next training frame, although this inherently introduces some inaccuracy that scales with the duration of the sampling period. Hence alternatively the frame can be included, and all training frames can include a frame number, time stamp, or other indicator of their position within the actual sequence of frames that were generated. This frame number or time stamp can then be included as part of the input. Optionally, the number or time stamp can loop (for example every M frames or few seconds) so that only a relative time difference can be learned consistently by the machine learning model.

The machine learning model may use one or more machine learning algorithms in order to learn a mapping between its inputs and outputs. Example suitable learning algorithms include linear regression, logistic regression, artificial neural networks, decision trees, support vector machines (SVM), random forests, and the K-nearest neighbour algorithm.

Once trained, the machine learning model may be used for inference—i.e. for predicting outputs for previously unseen input data. The machine learning model may perform classification and/or regression tasks. In a classification task, the supervised learning model predicts discrete class labels for input data, and/or assigns the input data into predetermined categories. In a regression task, the supervised learning model predicts labels that are continuous values. In the video game example, the trained machine learning model may be utilised to predict presence of the attribute within a sequence of previously unseen action frames, to predict which actions may be taken by a player during those action frames. For example, the machine learning model may be provided with video game data of a live game, and provide outputs for controlling a non-player character in that live game.

Returning to FIG. 2, the receiving unit 200 is configured to provide the one or more attribute sequences received as first data to the filtering unit 202. The filtering unit 202 applies a filter to the attribute sequence as part of generating the training dataset for the machine learning model.

As discussed above, it is a problem in datasets having underrepresented classes that the machine learning model trained on those datasets is biased towards more frequently occurring classes. When presence of an attribute is much less frequent than absence of that attribute, the machine learning model may be biased towards not predicting the attribute.

To address this problem for training machine learning models for predicting presence of an attribute, the present technique provides context information in the attribute sequence indicating proximity to a key frame. For example, the filtering unit may pad values of the attribute sequence for frames neighbouring key frames with a likelihood η (where η∈[0,1)), where n increases with proximity to a key frame.

For example, an attribute sequence included in the first data may indicate:

| Tₖ₋₅ | Tₖ₋₄ | Tₖ₋₃ | Tₖ₋₂ | Tₖ₋₁ | Tₖ | Tₖ₊₁ | Tₖ₊₂ | Tₖ₊₃ | Tₖ₊₄ |
|---|---|---|---|---|---|---|---|---|---|
| 0 | 0 | 0 | 0 | 1 | 1 | 1 | 0 | 0 | 0 |

In this example, “1” represents presence of the attribute and “0” represents absence of the attribute (although it will be appreciated that these values could be inverted to represent the same information). Each element of the attribute sequence corresponds to a training frame, indicated by “Tₖ₊ₙ”, where the presence of the attribute is centred at Tₖ. Tₖ₋₁, Tₖ, and Tₖ₊₁ are key frames, each being associated with presence of the attribute. It will be appreciated that the attribute sequence shown above represents a small section of an attribute sequence which may in practice be much longer.

In some examples, the attribute may represent a particular user input, such as a jump button being pressed. In the above example, the jump button may be pressed for the three frames Tₖ₋₁, Tₖ, and Tₖ₊₁, and not pressed for the preceding or following frames.

The filtered attribute sequence may indicate:

| Tₖ₋₅ | Tₖ₋₄ | Tₖ₋₃ | Tₖ₋₂ | Tₖ₋₁ | Tₖ | Tₖ₊₁ | Tₖ₊₂ | Tₖ₊₃ | Tₖ₊₄ |
|---|---|---|---|---|---|---|---|---|---|
| 0 | 0.1 | 0.4 | 0.6 | 1 | 1 | 1 | 0.6 | 0.4 | 0.1 |

In the filtered attribute sequence, the values corresponding to the three frames preceding the key frames and the three frames following the key frames have been modified to indicate proximity of the key frames. The padding values increase with proximity to the key frames.

It will be appreciated that the example given in the table above is merely to illustrate the concept of filtering the attribute sequence, and neither the selection of which frames are padded, nor the values chosen for padding, are to be considered as limiting.

By including padding values in the attribute sequence, the machine learning model is provided with context information which signals proximity to a key frame.

Returning to the jumping example, each of training frames Tₖ₋₅ to Tₖ may indicate an avatar approaching an obstacle. Without padding, when provided with the input training frame Tₖ₋₂, which may show the avatar close to an obstacle just before jumping, the attribute sequence indicates that this is a non-jumping frame. A machine learning model using the unfiltered attribute sequence would therefore learn to not jump even for frames where an avatar is very close to an obstacle. The machine learning model is provided with the same attribute for frames immediately before jumping as for frames where an avatar is nowhere near an obstacle, and hence the machine learning model may not learn to associate distance to an obstacle with a likelihood of jumping.

In contrast, when provided with the filtered attribute sequence, the machine learning model is provided with context information indicating an increasing likelihood of jumping as the obstacle approaches the avatar. Taking training frame Tₖ₋₂ for example, the filtered attribute sequence indicates a high likelihood of 0.6 of jumping. The machine learning model is therefore presented with a training frame indicating an avatar very close to an obstacle and the attribute information signalling that this frame is very close to a key frame, and hence the probability of jumping is high. The machine learning model is therefore provided with information which enables it to learn features which indicate proximity to a key frame in the sequence of training frames. For example, the machine learning model can learn that distance to the obstacle may signal an increased likelihood of jumping because the attribute sequence provides values correlated to the distance to the obstacle.

It will be appreciated that the same considerations apply in situations other than predicting a jump input in a video game, and this example is chosen merely for illustration. In general, filtering the attribute sequence to provide context information around key frames enables a machine learning model to learn how to predict key frames based on context clues in the surrounding frames.

The filtering circuitry 202 may apply the filter in various ways. In some examples, the filtering circuitry 202 may perform a convolution between the attribute sequence and a filter kernel.

The form of the filter itself could be varied to suit different situations. In general, the filter may be defined by a set of filter parameters which could be set according to a rule-based approach, or as discussed below could be learned during training of the machine learning model.

In some examples, the filter may be provided as a mixture of Gaussian kernels. For example, the filter kernel may be defined according to the following equation:

$$φ = {\sum }_{i} {c}_{i} N ( {μ}_{i} , {σ}_{i} )$$

Where N(μᵢ, σᵢ) is a Gaussian having mean μᵢ and standard deviation σᵢ, and cᵢ represents the contribution of each Gaussian to the filter. The filter may therefore be defined by the set of parameters μᵢ, σᵢ, and cᵢ for each value of i.

Returning to FIG. 2, the filtered attribute sequence is provided to the training unit 204 for training the machine learning model. The training unit 204 may also be provided input data (image data, audio data, etc.) for each of the training frames, and trains the machine learning model according to the techniques discussed above to predict occurrence of the attribute in training frames/action frames.

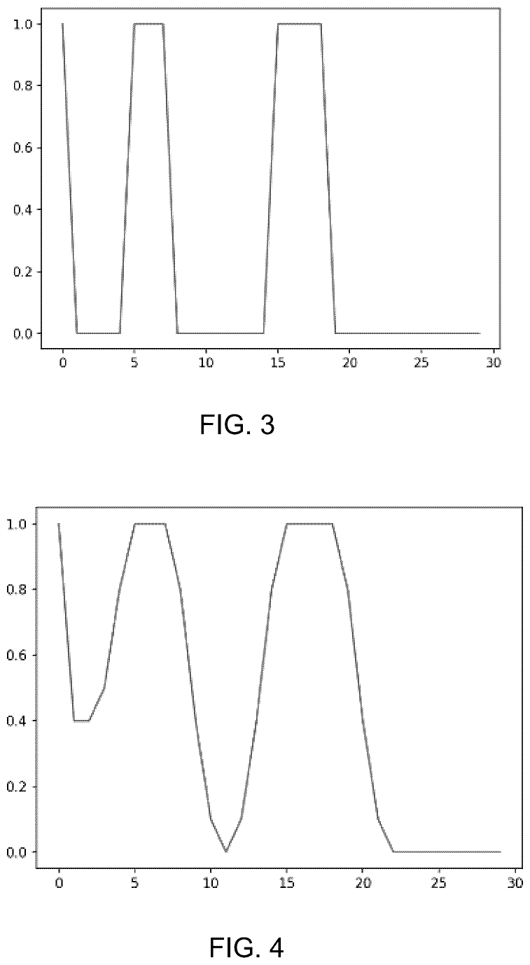

FIGS. 3 to 6 graphically illustrate examples of applying a filter to an attribute sequence.

FIG. 3 illustrates an unfiltered attribute sequence. Subsequent training frames are labelled along the x-axis, and the corresponding value of the attribute sequence is indicated along the y-axis. As shown in FIG. 3, the unfiltered attribute sequence is binary such that each value is either 0 or 1. This means that the machine learning model is provided with no information to allow it to distinguish frames directly next to a key frame from frames nowhere near a key frame, and hence it can be difficult to learn to recognise key frames, especially when key frames are underrepresented and occur in only a small fraction of training frames.

FIG. 4 illustrates an attribute sequence filtered using a symmetrical Gaussian filter. The symmetrical Gaussian filter is applied both before and after each set of key frames, and hence indicates proximity to a key frame for both frames before the key frame in a sequence and after the key frame in the sequence. FIG. 4 also illustrates that the filter may not affect the values of the attribute sequence for the key frames. The key frames are the frames with the highest likelihood of being associated with the particular attribute, so it may be counterproductive to reduce the likelihood value for the key frames, and hence the filtering unit may leave the values for the key frames unmodified. This could be implemented for example using a filter which is arranged to not modify the key frames. Alternatively, the filtering unit may restrict application of the filter such that, even if the key frames were to be modified by the filter, the filtering unit may prevent such modification of values for the key frames. For example, the filtering unit may restore key frame values following application of a filter.

In some examples of the present technique the filter may be applied differently to the frames before a key frame compared to the frames following a key frame. The context information for a particular attribute may be more relevant for frames either preceding or following a key frame, and hence providing a filtering unit supporting asymmetric filters may enable more accurate training of the machine learning model.

For example, for the action “jump” discussed above, it may be desirable for the machine learning model to have fine control over timing leading up to the jump action, and hence the attribute sequence for the frames preceding the key frames may be padded with filter values. However, once the jump action has taken place (e.g., once the avatar is safely over the obstacle), the jump action may no longer be relevant and hence it may be less relevant to train the machine learning model to recognise situations following a jump action. Hence, for the jump attribute the filter may apply to frames preceding the key frames but not to frames following the key frames. An example of filtering applied to frames preceding key frames (leading edge filtering) is shown in FIG. 5.

For different actions, the desired behaviour may be entirely different to “jump”, and hence a different filter may be applied. In particular, “shoot” may be a much less precise action than “jump” and hence the level of filtering may be reduced for “shoot” compared to “jump”. This may be represented by a smaller standard deviation in the filter used for “shoot” compared to “jump”.

In addition, an action such as “shoot” may be relevant both before the key frames and after the key frames (e.g., shooting may depend purely on proximity to an opponent, regardless of whether the opponent is approaching or moving away from an avatar), and hence the filter applied for the “shoot” attribute may be symmetrical about the key frames. An action such as “use” may also be relevant both before and after the key frames, but may be a much more precise action than “shoot”, and hence may be associated with filtering over a greater number of proximate training frames.

Finally, there may be some attributes which may be more relevant to frames following a key frame. For example, an input representing moving forward after the start of a race may be relevant for frames after the start of the race, but not for the frames before the start. Hence, some filters may focus on the frames following key frames. An example of filtering applied to frames following key frames (trailing edge filtering) is shown in FIG. 6.

It will be appreciated that while the above examples relate to video games, similar considerations apply across a range of different applications. For example, for controlling a self-driving car, an “apply brakes” attribute may be relevant for the frames following identification of a hazard and hence trailing edge filtering may be applied in this situation, whereas “steer left” may be relevant for frames leading up to a corner and hence leading edge filtering may be applied in this situation.

Many factors may determine the best choice of filtering parameters for a particular attribute, to enable that attribute to be predicted most accurately. In some examples, a rules-based approach may be appropriate to select filter parameters. However, in other examples, training may be further improved by using training of the machine learning model to also optimise the filter parameters. Therefore, FIG. 2 shows that the training unit 204 may provide filter parameter updates to the filter unit 202, enabling the filter to be updated during use.

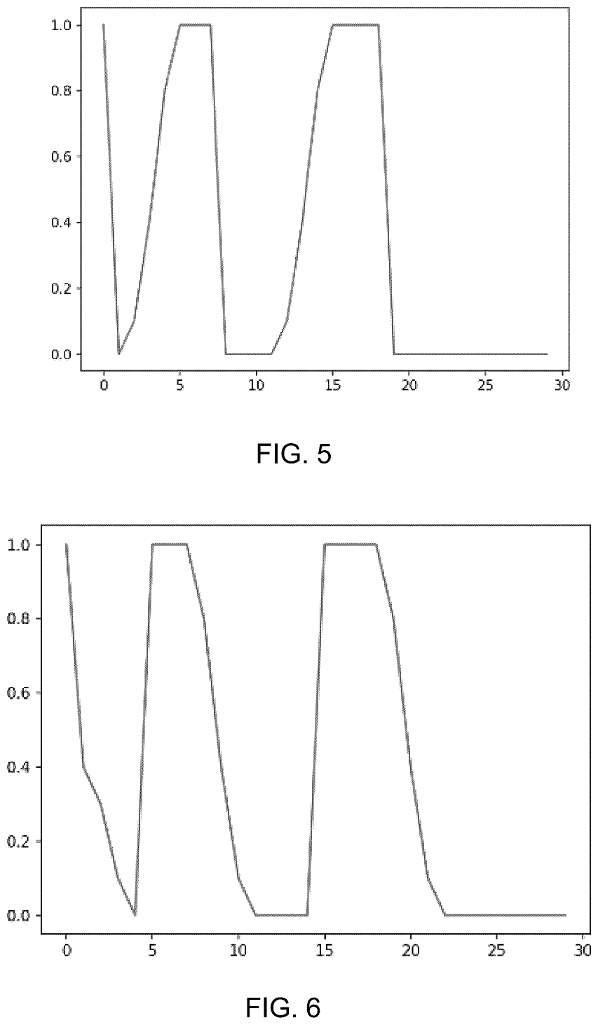

FIG. 7 schematically illustrates an example arrangement for training the machine learning model and also optimising filter parameters. Because the filter parameters may be closely related to the optimal weights for the network (e.g., optimal filtering parameters may be highly dependent on the use case), training the machine learning model and the filter parameters together can enable the most appropriate filter parameters to be selected for a given scenario, and can enable the filters to be different when applied to different attribute sequences.

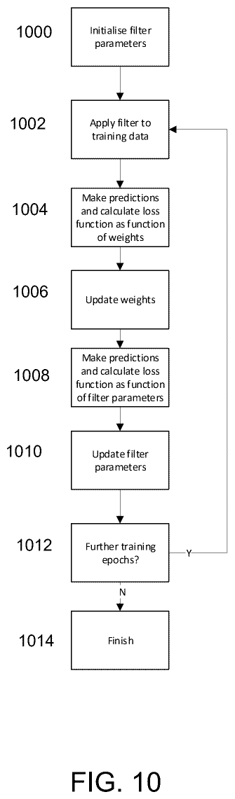

In the approach illustrated in FIG. 7, the filter parameters and network weights are initialised to initial values. At each of a series of training epochs (discussed further in FIG. 10), the network weights are updated for a fixed set of filter parameters, and the filter parameters are updated for a fixed set of network weights. This may be repeated until training of the machine learning model is complete.

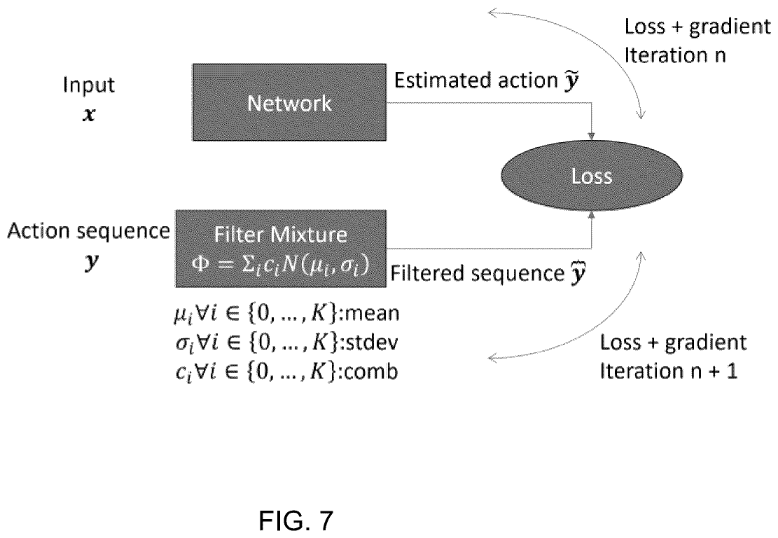

FIG. 8 is a flow diagram illustrating a method of training a machine learning model. At step 800, first data is received (e.g., by receiving unit 200) comprising an attribute sequence. At step 802, a filter is applied to the attribute sequence (e.g., by filtering unit 202) to provide context information in the attribute sequence indicating proximity of training frames to a key frame. Finally, at step 804 the filtered attribute sequence is provided for training a machine learning model (e.g., by training unit 204), for example in combination with data (video data etc.) characterising the sequence of training frames. Details of steps 800, 802, and 804 are as discussed above with respect to the elements shown in FIG. 2.

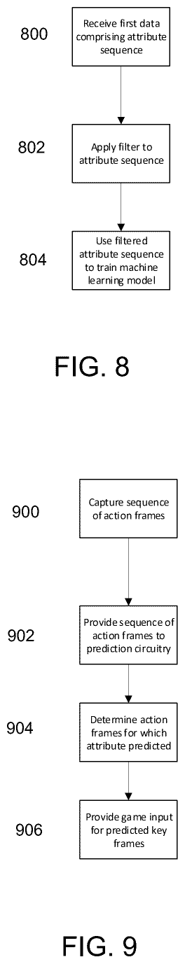

FIG. 9 is a flow diagram illustrating a method of using a machine learning model to control a video game.

At step 900, a game state capturing unit captures game state information representing a sequence of action frames of a game. An example game state capturing unit 206 is illustrated for example in FIG. 2.

Whilst the training frames may represent sampling points of a training dataset, the action frames may represent sampling points of a live dataset (e.g., a live video game). The action frames may comprise a similar amount of information as would be presented to a human user interacting with the game, to enable the machine learning model to make decisions using a similar amount of information as would be available to a human player. The action frames may be represented in a similar format to the training frames and, like the training frames, may be represented in various ways. For example, the action frames may comprise various types of data, such as numerical values, images, video, text, and/or audio. Raw input data may be pre-processed to obtain an appropriate feature vector used as an input to the model—for example, features of an image or audio input may be extracted to obtain a corresponding feature vector.

At step 902, the game state information representing a current state of a game is provided to prediction circuitry (e.g., prediction unit 208 in FIG. 2), thereby providing the game state information to a machine learning model trained using the method of FIG. 8. FIG. 2 illustrates the prediction unit 208 being provided the machine learning model by the training unit 204, although it will be appreciated that in practice the same circuitry may both train and use the machine learning model. The machine learning model has been trained to predict key frames in a series of training frames, and hence can be used to predict key frames (i.e., predict occurrence of the particular attribute) in the series of action frames.

Therefore, at step 904 the prediction unit 208 provides an output from the machine learning model indicating which frames are predicted to be key frames. This may be carried out on a frame-by-frame basis, indicating for example a prediction of whether the most recently provided action frame is a key frame or not. Hence, prediction may not necessarily refer to prediction of whether future frames are a key frame but may encompass prediction of whether a current frame is a key frame or not, allowing live prediction of what action to take based on a current state of a game. Key frames are frames predicted to be associated with a particular attribute, and when the particular attribute is a user input, then the prediction of key frames represents a prediction of whether a user may make a particular input at each action frame. Hence, prediction that a particular frame is a key frame may be used at step 906 by game input providing circuitry 210 to provide inputs to a game representing actions predicted to be taken by a human player. The inputs are based on identification of key frames and are hence based on a prediction of which, if any, of the action frames are predicted to be associated with the particular attribute. For example, if at least one of the action frames is predicted to be a key frame then a corresponding game input may be provided for those actions frames. If none of the action frames are predicted to be key frames then the correct behaviour of the machine learning model to most accurately represent a human player may be to provide no game inputs corresponding to a particular action for the series of action frames.

Hence, the steps shown in FIG. 9 enable a machine learning model trained according to the methods described herein to be utilised to make predictions representing the behaviour of a human player playing a video game. As described above, this can enable use of the machine learning model to control non-player characters (such as opponents for a multiplayer game) and to perform quality control testing for an in-game environment.

It will be appreciated that in the above techniques in which the machine learning model predicts whether a current frame is a key frame or not, the as described elsewhere herein that prediction may typically be expressed through the output of an attribute value (e.g. imitating the attribute for a key frame as learned from the training set). The output of the value may then be treated as a proxy for the corresponding user input (e.g. to jump, as per the examples herein).

It will also be appreciated that the above technique can be duplicated for different inputs, so that different ML models are trained to output different attributes corresponding to different controls in response to the training frames, so that proxies for a sufficient set of controls for at least some aspects of the game are provided.

However, separate ML models for each control input may place an unreasonable computational burden on the host system.

Therefore in embodiments of the present description, training frames may be associated with plural attribute sequences for respective control inputs (whether all or a subset of the controls to learn), and have key frames corresponding to plural control inputs. An ML model may then learn to imitate the attributes for these plural controls. Notably, there can be a significant correlation between some controls for some key frames, which can be detected and modelled by this approach. For example in the case of a user facing a rock and pressing jump, they may also press ‘forwards’ momentarily beforehand in order to specify a direction of jump (instead of, for example, just jumping directly upwards). This combination of user inputs may provide further discriminatory information to the ML during training and improve performance. Optionally, inputs that have recently occurred, as represented in the attribute sequences (optionally with filtering in the training set as described herein) may also be included as inputs alongside training frames to give further contextual information.

FIG. 10 is a flow diagram illustrating a method of training a machine learning model and filter parameters in a combined approach. The combined approach provides a series of training epochs, wherein machine learning model parameters (such as network weights) and filter parameters are both updated at each training epoch. It will however be appreciated that other machine learning approaches may be used to update the filter parameters and machine learning model parameters together.

At step 1000, filter parameters of an attribute sequence filter are initialised to initial values. The initial values may be selected in several ways, such as being chosen based on estimates for the final values of those parameters or simply being set to a predetermined value such as one. The initial values may not impact the final filter parameter values, but may impact how long training takes.

At step 1002, a filter defined by the current filter parameters is applied to the attribute sequence received as part of the first data.

At step 1004, the training circuitry 204 makes predictions for the presence of key frames in a set of training frames using a current machine learning model. A loss function is calculated based on the predicted outputs and the filtered attribute sequence.

At step 1006, the weights of the machine learning model are updated. For example, a gradient descent training approach may be used with gradients based on loss calculated as a function of network weights. The updating of network weights at step 1006 is carried out for a fixed set of filter parameters.

At step 1008, a loss function (e.g., between predicted outputs and the filtered attribute sequence) is calculated as a function of the filter parameters. The loss function may be calculated using the network weights updated in step 1006. At step 1010 the filter parameters are updated to minimise the loss function. The filter update at step 1010 is carried out for a fixed set of network weights.

It will be appreciated that in other examples of the present technique, the filter parameters may be updated before the network weights such that steps 1006 and 1008 are carried out in the opposite order.

Following step 1010, the network weights and filter parameters have undergone a training epoch in which each has been updated whilst the other is fixed. Many training epochs may be carried out before the machine learning model is considered fully trained. Hence, at step 1012 it is determined whether to perform further training epochs. This may for example be determined based on whether a numerical value of the loss function exceeds an acceptable threshold.

If it is determined that further training epochs are to be performed, then the process returns to step 1002, and further training epochs are carried out using the updated filter parameters and network weights. Otherwise, training is completed at step 1014.

The filter parameters provided by the training approach illustrated in FIG. 10 may be applied directly by the filter unit 202. In some examples, the filter parameters may be further optimised manually before being applied by the filtering unit 202.

It will be appreciated that the above methods may be carried out on conventional hardware (such as entertainment device 10) suitably adapted as applicable by software instruction or by the inclusion or substitution of dedicated hardware.

The techniques described herein may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the disclosure have been described in detail herein with reference to the accompanying drawings, it is to be understood that the disclosure is not limited to those precise embodiments, and that various changes and modifications can be effected therein by one skilled in the art without departing from the scope of the disclosure as defined by the appended claims.

1. A system for training a machine learning model, the system comprising:
a receiving unit configured to receive first data comprising an attribute sequence providing a sequence of values each indicating whether a particular attribute is associated with a respective one of a sequence of training frames, training frames so associated being referred to as key frames;
a training unit configured to train the machine learning model, using a training dataset, to generate behaviour for an agent to predict occurrence of the particular attribute within a sequence of action frames; and
a filtering unit configured to apply a filter to the attribute sequence to generate the training dataset, wherein the filter modifies values of the attribute sequence for at least some training frames proximate to a given key frame, to provide context information in the training dataset indicating proximity to a key frame for frames within the sequence of training frames.

2. The system of claim 1, wherein properties of the filter are defined by a set of filter parameters, and
the training unit is configured to update the filter parameters during training of the machine learning model.

3. The system of claim 2, wherein the training unit is configured to perform an iterative update process comprising a sequence of training epochs to train the machine learning model and update the filter parameters, wherein at each training epoch the training unit is configured to:
update parameters of the machine learning model for a fixed set of filter parameters, and
update the filter parameters for a fixed set of machine learning model parameters.

4. The system of claim 1, wherein the particular attribute is an infrequent attribute in the sequence of training frames.

5. The system of claim 1, wherein the particular attribute indicates presence of a user input for the corresponding training frame.

6. The system of claim 1, wherein the context information provides a value for at least some training frames which increases with proximity within the sequence of training frames to a key frame.

7. The system of claim 1, wherein the filtering unit is arranged to leave values of the attribute sequence unmodified for key frames.

8. The system of claim 1, wherein the filtering unit is configured to apply the filter by performing a convolution of the attribute sequence and the filter.

9. The system of claim 1, wherein the filter is arranged to modify values of the attribute sequence for training frames preceding key frames independently from modification of values of the attribute sequence for training frames following key frames.

10. The system of claim 1, wherein the filter comprises a mixture of Gaussian functions.

11. The system of claim 1, wherein the training dataset comprises a plurality of attribute sequences, and the filtering unit is configured to apply different filters to different attribute sequences to generate the training dataset.

12. The system of claim 1, wherein the training unit is configured to train the machine learning model using an imitation learning method.

13. The system of claim 1, wherein the training data comprises video data comprising image frames corresponding to the sequence of training frames.

14. The system of claim 1, further comprising:
a game state capturing unit configured to capture game state information representing the sequence of action frames;
a prediction unit configured to provide the game state information to the machine learning model trained using the system to predict occurrence of the particular attribute within the sequence of action frames; and
a game input providing unit configured to provide a game input determined based on which of the action frames are predicted to be associated with the particular attribute.

15. A method of training a machine learning model, the method comprising:
receiving training data comprising an attribute sequence providing a sequence of values indicating whether a particular attribute is associated with each of a sequence of training frames;
applying a filter to the attribute sequence to generate a training dataset, wherein the filter is arranged to modify values of the attribute sequence for non-attribute training frames not associated with the particular attribute to provide context information indicating that a training frame nearby in the sequence of training frames is an attribute training frame associated with the particular attribute; and
training the machine learning model, using the training dataset, to generate behaviour for an agent to predict occurrence of the particular attribute within a sequence of action frames.

16. The method of claim 15, wherein:
properties of the filter are defined by a set of filter parameters, and
the method further comprises updating the filter parameters during training of the machine learning model.

17. The method of claim 16, further comprising performing an iterative update process comprising a sequence of training epochs to train the machine learning model and update the filter parameters, wherein at each training epoch the iterative update process comprises:
updating parameters of the machine learning model for a fixed set of filter parameters, and
updating the filter parameters for a fixed set of machine learning model parameters.

18. The method of claim 15, wherein the particular attribute is an infrequent attribute in the sequence of training frames.

19. The method of claim 15, wherein the particular attribute indicates presence of a user input for the corresponding training frame.

20. A non-transitory computer-readable medium storing instructions that, when executed by one or more processors, cause the one or more processors to perform operations comprising:
receiving training data comprising an attribute sequence providing a sequence of values indicating whether a particular attribute is associated with each of a sequence of training frames;
applying a filter to the attribute sequence to generate a training dataset, wherein the filter is arranged to modify values of the attribute sequence for non-attribute training frames not associated with the particular attribute to provide context information indicating that a training frame nearby in the sequence of training frames is an attribute training frame associated with the particular attribute; and
training a machine learning model, using the training dataset, to generate behaviour for an agent to predict occurrence of the particular attribute within a sequence of action frames.
